(19) United States
(12) Patent Application Publication
(10) Pub. No.: US 2021/0403798 A1
(43) Pub. Date: Dec. 30, 2021

(54) PREVENTING WATER PRODUCTION IN SUBTERRANEAN FORMATIONS

(71) Applicant: Saudi Arabian Oil Company, Dhahran (SA)

(72) Inventors: Rajendra Arunkumar Kalgaonkar, Abqaiq (SA); Vikrant Bhavanishankar Wagle, Dhahran (SA); Mohammed A. Bataweel, Dhahran (SA)

(21) Appl. No.: 16/917,273

(22) Filed: Jun. 30, 2020

(51) Int. Cl. C09K 8/60; C09K 8/92; C08K 3/22; C08K 3/36; C08K 3/26

(52) U.S. Cl. CPC C09K 8/601; C09K 8/92; C08K 3/22; C08K 3/36; C08K 3/26; B82Y 30/00; C08K 2003/2227; C08K 2003/2265; C08K 2201/005; C08K 2201/011; C09K 2208/10

(57) ABSTRACT

A method and a system for preventing water production in subterranean formations are provided. An exemplary system disclosed a water shutoff material for a wellbore. The water shutoff material includes a gel formed from an acidic suspension of nanosilica particles and an activator.

### TECHNICAL FIELD

The present disclosure is directed to compositions for limiting co-produced water with gels formed using nanosilica particles.

### BACKGROUND

The production of crude oil and other hydrocarbons starts with the drilling of a wellbore into a hydrocarbon reservoir. In many cases, the hydrocarbon reservoir is a narrow layer of material in the subterranean environment, wherein other layers have high water content. Further, as a well is produced, previously productive layers may start producing higher amounts of water.

Excessive water production greatly affects the economic life of producing wells. High water cut largely affects the economic life of producing wells and is also responsible for many damage mechanisms related to oilfield equipment such as scale deposition, fines migration, asphaltene precipitation, and corrosion. This also leads to increased operating costs to separate, treat, and dispose of the produced water according to environmental regulations. Though a variety of chemicals are used by the industry to control water production, most of them are not accepted in regions that have strict environmental regulations.

### SUMMARY

An embodiment described herein provides a method for controlling unwanted water production in a water producing zone in a subterranean formation. The method includes flowing an acidic suspension of nanosilica particles into a wellbore such that it contacts the water producing zone, and flowing an activator into the wellbore such that it contacts the acidic suspension in the water producing zone, producing a composition. The wellbore is shut in for a duration of time sufficient for the composition to form a gel that is impermeable to fluid flow.

Another embodiment disclosed herein provides a water shutoff material for a wellbore. The water shutoff material includes a gel formed from an acidic suspension of nanosilica particles and an activator.

### BRIEF DESCRIPTION OF DRAWINGS

FIG. 1 is a schematic drawing of a wellbore, showing increased production of water in a reservoir layer in a subterranean formation.

FIG. 2 is a schematic drawing of a method of sealing a section of a wellbore to decrease coproduction of water 104 using an acidic suspension of nanosilica particles.

FIG. 3 is a process flow diagram of a method for shutting off water from a zone in a well.

FIG. 4 is a schematic diagram of a gelling reaction.

### DETAILED DESCRIPTION

Compositions are provided herein for preventing unwanted water production by shutting off water producing zones. The compositions are based on an activation chemistry to form a gel from acidic suspensions of nanosilica particles. The nanosilica particles are generally considered environmentally benign and the chemicals disclosed herein for treatment and activation also do not cause environmental issues.

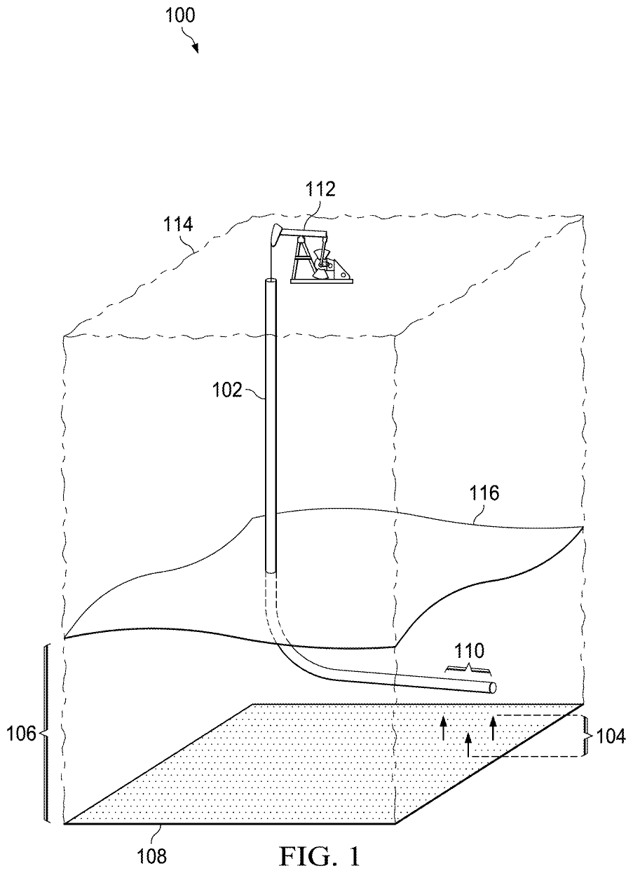

FIG. 1 is a schematic drawing 100 of a wellbore 102, showing increased production of water 104 in a reservoir layer 106 in a subterranean formation. The water 104 may come from an underlying water table, or water layer 108, below the reservoir layer 106. A section 110 of the wellbore 102 closest to the water layer 108 may draw water 104 into the wellbore 102 during the pumping cycle of a pump jack 112 at the surface 114, increasing the amount of produced water.

In other circumstances, a continuous production from the reservoir layer 106 to the surface 114 may entrain water 104 from the water layer 108, increasing the amount of water 104 produced from the section 110 of the wellbore. Further, as the reservoir layer 106 is produced, the amount of hydrocarbons between the water layer 108 and a cap rock layer 116 decreases, which may allow the water layer 108 to draw closer to the cap rock layer 116, moving closer to the section 110 of the wellbore 102. This may also increase the amount of water 104 produced.

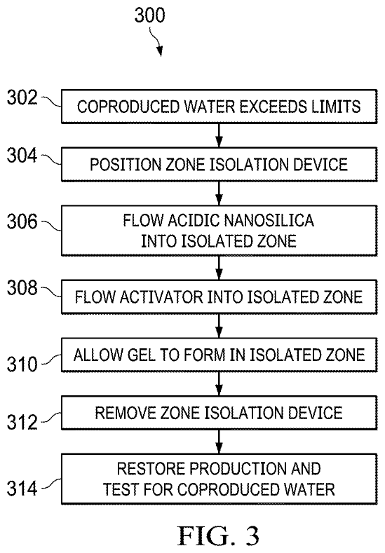

In various embodiments described herein, nanosilica particles may be used to form a gel, blocking production from the section 110 of the wellbore 102. As described further with respect to FIG. 3, in various embodiments, an acidic suspension of the nanosilica particles is injected into the wellbore 102 to the section 110 to be shut off. The acidic suspension of the nanosilica particles may be pushed into the section 110, for example, through the perforations in the production tubing at that point. The activator may then be injected into the wellbore 102, causing the gelation of the nanosilica particles.

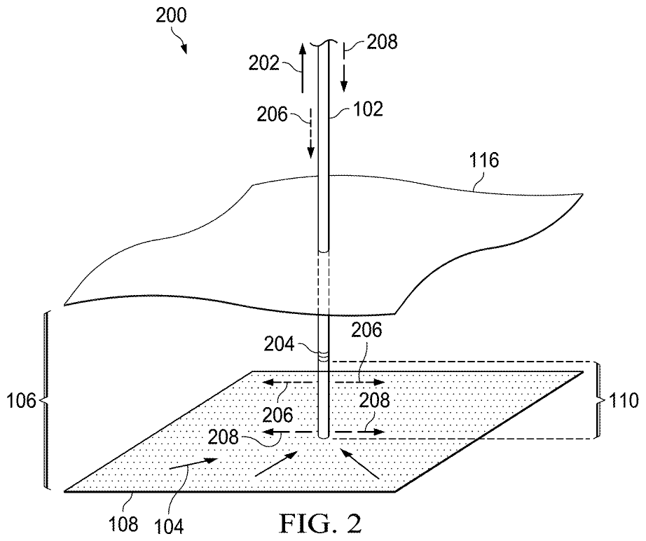

FIG. 2 is a schematic drawing of a method 200 of sealing a section 110 of a wellbore 102 to decrease coproduction of water 104 using an acidic suspension of nanosilica particles. Like numbered items are as described with respect to FIG. 1. In the example shown in FIG. 2, the wellbore 102 is shown as vertical. However, as shown in the example of FIG. 1, the wellbore can be directionally drilled into the reservoir layer 106.

The method 200 begins when the produced fluids 202 include an unacceptable amount of water 104, for example, coproduced from a water layer 108. The section 110 of the wellbore 102 closest to the water layer 108 may be responsible for the majority of the water 104 that is coproduced. Accordingly, sealing off this section 110 will lower the amount of water 104 in the produced fluids 202.

To begin, a zonal isolation tool, such as a packer 204, may be placed in the wellbore 102 to isolate the section 110 responsible for the majority of the production of the water 104. Once the packer 204 is in place, an acidic suspension 206 of nanosilica particles is injected into the wellbore 102, for example, through a coil tubing line to the section 110 that is being sealed off. The acidic suspension 206 of the nanosilica particles may be forced through the section 110 of the wellbore 102 and into the portion of the reservoir layer 106 surrounding the section 110.

After the acidic suspension 206 is injected into the wellbore 102, an activator 208 is injected through the wellbore 102 and into the section 110. The activator 208 initiates the gelling of the nanosilica particles in the perforations of the section 110 and in the associated region of the reservoir layer 106. The formation of the gel may then seal the section 110 of the wellbore 102 and the associated region of the reservoir layer 106, decreasing or eliminating the coproduction of water 104.

Once the gelation is completed, the packer 204 may be removed from the wellbore 102. Production is restarted and the amount of water in the produced fluids 202 is determined to ensure that the sealing of the section 110 was successful.

The use of the gel for shutting off regions that are producing water allows for a simpler solution than leaving packers or other zonal isolation devices in the well for long periods of time. Further, sealing of the reservoir layer 106 associated with the section 110 of the wellbore 102 allows for continuing production of lower zones without placing restrictions due to zonal isolation devices in the wellbore 102.

FIG. 3 is a process flow diagram of a method 300 for shutting off water from a zone in a well. The method 300 begins at block 302 with a determination that the coproduced water has exceeded acceptable limits. For example, the coproduced water may be greater than about 1 vol. % of the produced fluids, greater than about 5 vol. %, or greater than about 25 vol. %. A determination is made as to the location, or source, of the produced water in the wellbore. This may be performed using a coil tubing in an underbalanced condition to measure the water at different locations in the wellbore to identify the section of the wellbore to be sealed.

Once the source of the produced water is identified, at block 304, a zone isolation device is placed to isolate the zone from other portions of the wellbore. The zone isolation device may be a packer, or other zonal isolation system, that is placed in the production tubing, outside the production tubing in the wellbore, or both. If the layer that is the source of the produced water is in an intermediate position in the wellbore, for example, lying both above and below productive zones, multiple zonal isolation devices may be used to isolate that portion of the wellbore for sealing.

Once the zonal isolation device is in place, at block 306 an acidic suspension of nanosilica particles may be pumped into the isolated zone. This may be performed at sufficient pressure to push the acidic suspension of nanosilica particles into the portion of the reservoir layer that is producing water.

In some embodiments, the acidic suspension of nanosilica particles includes a cationic acidic colloidal silica, for example, wherein the surface of the nanosilica particles is modified with a cationic species, such as a high valence metal ion or a cationic polymer. Metal ions that may be used include aluminum and iron. The cationically modified species may be stabilized using an anionic counter ion, such as chloride or oxychloride, among others. In other embodiments, the surface of the nanosilica particles in the colloid are not modified.

In some embodiments, the nanosilica particles may include other metal oxides, in addition to the silicon dioxide. In some embodiments, the additional oxide is an aluminum oxide or boron oxide. Boron-modified silica sols are described in, for example, U.S. Pat. No. 2,630,410. In some embodiments, alumina-modified silica particles have an Al₂O₃ content of from about 0.05 to about 3 weight percent (wt. %), for example from about 0.1 to about 2 wt. %. The procedure of preparing an alumina-modified silica sol is described, for example, in “The Chemistry of Silica,” by Iler, K. Ralph, pages 407-409, John Wiley & Sons (1979) and in U.S. Pat. No. 5,368,833.

In some embodiments, the silica in the nanosilica particles does not contain any added additional oxides. In some embodiments, the nanosilica particles contain no more than trace or impurity amounts in each case, for example less than 1000 parts per million (ppm) by weight each of additional oxides. In some embodiments, the total amount of non-silica oxides present in the sol is less than about 5000 ppm by weight, such as less than about 1000 ppm.

In some embodiments, the nanosilica particles have an average particle diameter ranging from about 2 to about 150 nm, such as from about 3 to about 50 nm, or from about 5 to about 25 nm. In some embodiments, the average particle diameter is in the range of from about 6 to about 20 nm. In some embodiments, the nanosilica particles have a specific surface area from about 20 to about 1500 m² g⁻¹, such as from about 50 to about 900 m² g⁻¹, from about 70 to about 600 m² g⁻¹, or from about 70 to about 400 m² g⁻¹, or about 160 m² g⁻¹.

In some embodiments, the acidic suspension of the nanosilica particles may be between about 10 wt. % and about 50 wt. % silica (SiO₂), or between about 15 wt. % and about 35 wt. % silica, or about 25 wt. % silica. In some embodiments, the acidic suspension of nanosilica particles is between about 5 wt. % and about 50 wt. % solids, between about 20 wt. % and about 40 wt. % solids, or about 31 wt. % solids. In some embodiments, the pH of the acidic suspension is between about 1 and about 6, or between about 2 and about 5, or between about 3 and about 4, or about 3.8. In some embodiments, the viscosity of the acidic suspension, in centipoise (cP), is between about 1 and about 6, or between about 2 and about 5, or about 3 cP. In some embodiments, the density of the acidic suspension may be between about 1.1 g cm⁻³ and about 1.4 g cm⁻³, or about 1.2 g cm⁻³.

In some embodiments, the acidic suspension of nanosilica particles is a commercially available product, for example, from the Levasil® product line, available from the Nouryon Company, Amsterdam, The Netherlands.

At block 308, an activator solution is pumped into the isolated zone. The activator triggers the gelation of the nanosilica particles in the acidic suspension, forming an impermeable gel that seals the portion of the reservoir. In some embodiments, the activator is a salt of a multivalent anion, for example, that increases the pH. In some embodiments, the activator is solution of sodium bicarbonate. In some embodiments, the amount of activator used is between about 5% and about 50%, by weight, of the acidic suspension of nanosilica particles. In some embodiments, the amount of activator used is between about 15% and about 35%, by weight, of the acidic suspension of nanosilica particles. In some embodiments, the amount of activator used is about 25%, by weight, of the acidic suspension of nanosilica particles.

In some embodiments, the activator is a salt. In some embodiments, the activator is an organic salt. In some embodiments, the activator is an inorganic salt. In some embodiments, the salt is selected from halides, phosphates, silicates, sulfates, nitrates, carbonates, carboxylates, oxalates, sulfides, and hydroxides. In some embodiments, the salt is a carbonate.

In some embodiments, the activator includes an anion. In some embodiments, the anion is selected from a halide (such as chloride, bromide or iodide), carbonate, hydroxide, sulfate, nitrate, silicate, aluminate, phosphate, hydrogen phosphate, carboxylate, or oxalate. In some embodiments, the activator includes a cation. In some embodiments, the cation is selected from alkali metals, alkaline earth metals, hydrogen, main group metals (for example, aluminum, gallium, indium, or tin), ammonium ions, including primary ammonium, secondary ammonium, tertiary ammonium, and quaternary ammonium ions, and organic cations such as amino and organoamino ions.

In some embodiments, the activator is a silicate. In some embodiments, the activator is sodium silicate or potassium silicate. In some embodiments, the activator is sodium chloride. In some embodiments, the activator is a hydroxide. In some embodiments, the activator is an alkali metal hydroxide, ammonium hydroxide or organoammonium hydroxide.

In some embodiments, the cation of the activator is a monovalent cation. In some embodiments, the monovalent cation is a proton, an alkali metal cation, ammonium ion, or organoammonium ion. In some embodiments, the monovalent cation is an alkali metal cation. In some embodiments, the alkali metal cation is lithium, sodium, or potassium.

In some embodiments, the pumping of the acidic suspension of nanosilica particles is alternated with the pumping of the activator solution, allowing the formation of layers of gel deeper in the rock of the reservoir.

At block 310, the gel is allowed to form in the isolated zone. This may be performed by shutting in the well for a sufficient period of time to allow the gel to form before proceeding to further steps. The gelation may be complete in about one hour, about two hours, about five hours, about 10 hours, or about 20 hours. The gelation time, and the properties of the final gel, may be controlled by the ratio of the nanosilica particles to the activator.

At block 312, the zonal isolation device is removed. If multiple zonal isolation devices were used, for example, at the top and bottom of a layer contributing to coproduced water, they both may be removed to allow production from lower levels in the reservoir.

At block 314, production is restored and the produced fluids are tested for coproduced water. If the amount of coproduced water is still too high, the procedure may be needed for other zones in the reservoir.

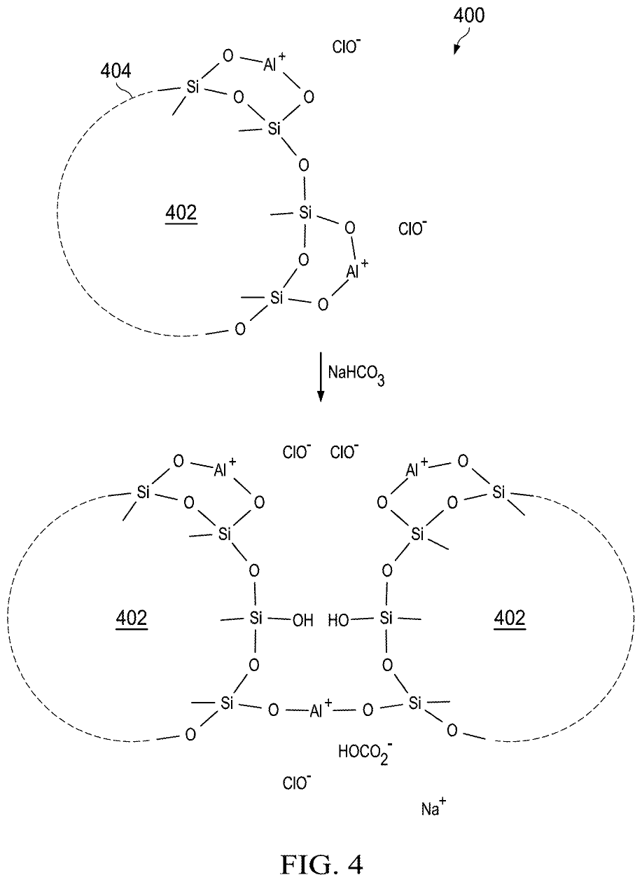

FIG. 4 is a schematic diagram 400 of a gelling reaction. In this embodiment, the nanosilica particles 402 have a surface that is cationic, formed by the reaction of the OH groups on the surface 404 of the nanosilica particles 402 with aluminum ions. In this embodiment, the nanosilica particles 402 are stabilized from agglomeration by the presence of ClO⁻ anions. However, as described herein, other anions, such as chloride ions, may be used for stabilization.

In this embodiment, the addition of the sodium bicarbonate (NaHCO₃) activator initiates the gelling of the nanosilica particles 402. The gelling reaction may be through opening of Al—O bonds to allow the formation of —O—Al—O— bonds between nanosilica particles 402, coupling the nanosilica particles 402 to each other to form a network. Other gelling reactions may be present, depending on the surface modification of the nanosilica particles 402, or lack thereof. In some embodiments, —Si—O—Si-bonds may form between nanosilica particles 402 forming a network.

It should be noted that any number of other metal ions may be used for the surface modification of the nanosilica particles 402. For example, the Al(III) ions shown in FIG. 4 could be replaced with Fe(III) ions. Other cations could be used in addition to, or instead of, aluminum and iron ions, such as boron ions, among others. These would be formed by the reaction of the chloride salts of the ions with the OH groups of the nanosilica particles 402.

### Example

The gelation of the present systems was tested using an acidic suspension of nanosilica particles, specifically, Levasil® CS30-516 P obtained from the Akzo Nobel Company (predecessor company to Nouryon). The properties of the material are shown in Table 1.

TABLE 1
Typical properties of Levasil ® CS30-516 P

| | |
|---|---|
| SiO2 (wt. %) | 25 |
| Specific surface area (m² g⁻¹) | 160 |
| Surface area via BET (m² g⁻¹)¹ | 200 |
| pH | 3.8 |
| Viscosity (cP) | 3.0 |
| Density (g cm⁻³) | 1.2 |

¹Brunauer-Emmett-Teller used to calculate surface area from an adsorption isotherm of a gas monolayer.

The gelation was tested by adding 20 g of sodium bicarbonate to 80 g of the acidic suspension of nanosilica particles in a beaker to form a dispersion. The dispersion was mixed using a stirrer, then subject to a pressure of 690 kPa (100 psi) at a temperature of about 121° C. (250° F.) for 16 hours. After the aging was complete, the dispersion was converted into a solid.

An embodiment described herein provides a method for controlling unwanted water production in a water producing zone in a subterranean formation. The method includes flowing an acidic suspension of nanosilica particles into a wellbore such that it contacts the water producing zone and flowing an activator into the wellbore such that it contacts the acidic suspension in the water producing zone producing a composition. The wellbore is shut in for a duration of time sufficient for the composition to form a gel that is impermeable to fluid flow.

In an aspect, the method includes determining that coproduced water exceeds acceptable limits. In an aspect, the method includes placing a zonal isolation device above the water producing zone prior to flowing the acidic suspension of nanosilica particles into the wellbore. In an aspect, the method includes placing a zonal isolation device below the water producing zone prior to flowing the acidic suspension of nanosilica particles into the wellbore.

In an aspect, the method includes pumping the acidic suspension of the nanosilica particles into the water producing zone. In an aspect, the method includes pumping a solution of the activator into the water producing zone after the acidic suspension of the nanosilica particles.

In an aspect, the method includes alternating between flowing the acidic suspension of the nanosilica particles into the water producing, and flowing a solution of the activator into the water producing zone after the acidic suspension of the nanosilica particles.

In an aspect, the method includes removing a zonal isolation device from above the water producing zone after the formation of the gel. In an aspect, the method includes removing a zonal isolation device from below the water producing zone after the formation of the gel.

In an aspect, the acidic suspension of the nanosilica particles includes a cationic surface including a metal complexed to oxygen ions. In an aspect, the metal includes aluminum. In an aspect, the activator includes sodium bicarbonate. In an aspect, the activator includes an alkali salt of hydrogen phosphate, carbonate, borate, or hydroxide, or any combinations thereof.

Another embodiment disclosed herein provides a water shutoff material for a wellbore. The water shutoff material includes a gel formed from an acidic suspension of nanosilica particles and an activator.

In an aspect, the acidic suspension of nanosilica particles includes a cationic surface including a metal complexed to oxygen ions on the surface. In an aspect, the metal includes aluminum. In an aspect, the metal includes iron. In an aspect, the activator includes an alkaline compound. In an aspect, the activator includes sodium bicarbonate. In an aspect, the activator includes an alkali salt of hydrogen phosphate, carbonate, borate, or hydroxide, or any combinations thereof.

Other implementations are also within the scope of the following claims.

What is claimed is:

1. A method for controlling unwanted water production in a water producing zone in a subterranean formation, comprising:
flowing an acidic suspension of nanosilica particles into a wellbore such that it contacts the water producing zone;
flowing an activator into the wellbore such that it contacts the acidic suspension in the water producing zone producing a composition; and
shutting in the wellbore for a duration of time sufficient for the composition to form a gel that is impermeable to fluid flow.

2. The method of claim 1, comprising determining that coproduced water exceeds acceptable limits.

3. The method of claim 1, comprising placing a zonal isolation device above the water producing zone prior to flowing the acidic suspension of nanosilica particles into the wellbore.

4. The method of claim 1, comprising placing a zonal isolation device below the water producing zone prior to flowing the acidic suspension of nanosilica particles into the wellbore.

5. The method of claim 1, comprising pumping the acidic suspension of the nanosilica particles into the water producing zone.

6. The method of claim 1, comprising pumping a solution of the activator into the water producing zone after the acidic suspension of the nanosilica particles.

7. The method of claim 1, comprising alternating:
flowing the acidic suspension of the nanosilica particles into the water producing; and
flowing a solution of the activator into the water producing zone after the acidic suspension of the nanosilica particles.

8. The method of claim 1, comprising removing a zonal isolation device from above the water producing zone after the formation of the gel.

9. The method of claim 1, comprising removing a zonal isolation device from below the water producing zone after the formation of the gel.

10. The method of claim 1, wherein the nanosilica particles comprise a cationic surface comprising a metal complexed to oxygen ions.

11. The method of claim 10, wherein the metal comprises aluminum.

12. The method of claim 1, wherein the activator comprises sodium bicarbonate.

13. The method of claim 1, wherein the activator comprises an alkali salt of hydrogen phosphate, carbonate, borate, or hydroxide, or any combinations thereof.

14. A water shutoff material for a wellbore, comprising a gel formed from:
an acidic suspension of nanosilica particles; and
an activator.

15. The water shutoff material of claim 14, wherein the acidic suspension of nanosilica particles comprises a cationic surface comprising a metal complexed to oxygen ions on a surface of the nanosilica particles.

16. The water shutoff material of claim 15, wherein the metal comprises aluminum.

17. The water shutoff material of claim 15, wherein the metal comprises iron.

18. The water shutoff material of claim 14, wherein the activator comprises an alkaline compound.

19. The water shutoff material of claim 14, wherein the activator comprises sodium bicarbonate.

20. The water shutoff material of claim 14, wherein the activator comprises an alkali salt of hydrogen phosphate, carbonate, borate, or hydroxide, or any combinations thereof.
